(19) United States
(12) Patent Application Publication
(10) Pub. No.: US 2025/0134222 A1
(43) Pub. Date: May 1, 2025

(54) METHOD FOR OBTAINING AN ITEM WITH A SPARKLING POLYCRYSTALLINE SURFACE

(71) Applicant: The Swatch Group Research and Development Ltd, Marin (CH)

(72) Inventors: Loïc CURCHOD, Lausanne (CH); Michel SAGARDOYBURU, Neuchâtel (CH); Yves WINKLER, Schmitten (CH); Simon SPRINGER, Berne (CH)

(73) Assignee: The Swatch Group Research and Development Ltd, Marin (CH)

(21) Appl. No.: 18/809,497

(22) Filed: Aug. 20, 2024

(30) Foreign Application Priority Data
Oct. 26, 2023 (EP) 23206212.5

(51) Int. Cl. A44C 27/00; G04B 19/12; G04B 45/00

(52) U.S. Cl. CPC A44C 27/00; G04B 19/12; G04B 45/0076

(57) ABSTRACT

A method for obtaining a decorative item (5) having a sparkling appearance, comprising the steps of: providing or producing a model (1) having a face (1a) of polycrystalline structure which is intended to be replicated; producing a replica (2) of the face (1a) using a polymer material; producing an object (4) on at least a portion of the replicated face (2a) of the replica (2); and at least one of locally modifying the polycrystalline structure of the model (1) before producing the replica (2); modifying the shape of the replica (2); and selectively producing the object (4) on certain portions of the replicated face (2a) of the negative replica (2), the decorative item (5) being either the replica (2), or the object (4) if the optional step is carried out.

### CROSS REFERENCE TO RELATED APPLICATIONS

This application is claiming priority based on European Patent Application No. 23206212.5 filed on Oct. 26, 2023.

### TECHNICAL FIELD OF THE INVENTION

The present invention relates to a method for producing an item having a sparkling effect, preferably a precious material appearance, on at least one of its surfaces. In particular, said item is an external timepiece component such as a dial.

### TECHNOLOGICAL BACKGROUND

Methods are known in the prior art for producing an item with a decorative surface structure, using a method for replicating a model having said decorative surface structure. The method is based on polymer moulding, either used as such with a decorative PVD layer, or followed by replication by hot stamping of amorphous metal as described in the patent document U.S. Pat. No. 5,950,704, or by galvanic growth as diagrammatically shown in FIG. 2 of the drawings appended hereto. A model 1 with a structure 1a is provided (A). A polymer layer forming a negative replica 2 is moulded onto the structure 1a of the model 1 (B). The model 1 is removed and a conductive layer 3 is deposited on the cavity 2a of the negative replica 2 (C). A metallic layer 4 is deposited, by galvanic growth, on the face of the replica 2 with the cavity 2a (D). The replica 2 is removed, leaving an item 5 which is a copy of the original model 1 (E). Optionally, this item 5 can be reused as a model to make additional parts. The polymer negative replica 2 can also be the final item.

### SUMMARY OF THE INVENTION

The invention aims to refine this replication method to produce an item with a sparkling polycrystalline surface, optionally with a precious material appearance. More specifically, the method is adapted to give the surface of the item a particular shape and/or a particular optical effect for decorative and/or functional purposes.

More specifically, the invention relates to a method for obtaining a decorative item having a sparkling appearance, said method comprising the steps of:
Providing or producing a model having a face of polycrystalline structure which is intended to be replicated,
Producing a negative replica of said face using a polymer material,
Separating the model from the replica,
Followed by an optional step of:
Producing an object, also referred to as a positive replica, on at least a portion of the replicated face of the negative replica,
   the method being characterised in that one or more actions are implemented during the aforementioned steps to impart particular optical effects and/or a functional appearance to the decorative item, one or more of the actions being selected from the following:
Locally modifying the polycrystalline structure of the model,
Modifying the shape of the negative replica,
Selectively producing the object on certain portions of the replicated face of the negative replica,
   the decorative item being either the negative replica, or the object if the optional step is carried out.

The sparkling and optionally precious appearance of the item is conferred by the polycrystalline nature of the model with special decorative effects linked to the controlled variation in the growth of the crystals during the production of the model or after production by patterning the crystals. The more or less precious appearance of the item will depend on the choice of material for the positive replica and the finishing treatments applied to the item after replication.

Other decorative effects can be obtained when making the object by giving the negative replica a particular shape or by selectively producing the object on the negative replica.

A functional aspect can also be added by this particular shaping of the replica, by the selective production of the object or by the modification of the model by, for example, inscribing hidden data (logo, serial number, etc.).

Another aspect of the invention relates to the item obtained by said method.

### BRIEF DESCRIPTION OF THE FIGURES

FIG. 1 shows a decorative item, in particular a dial, obtained using the method according to the invention.

FIG. 2 diagrammatically shows a method for obtaining an item by replication according to the prior art.

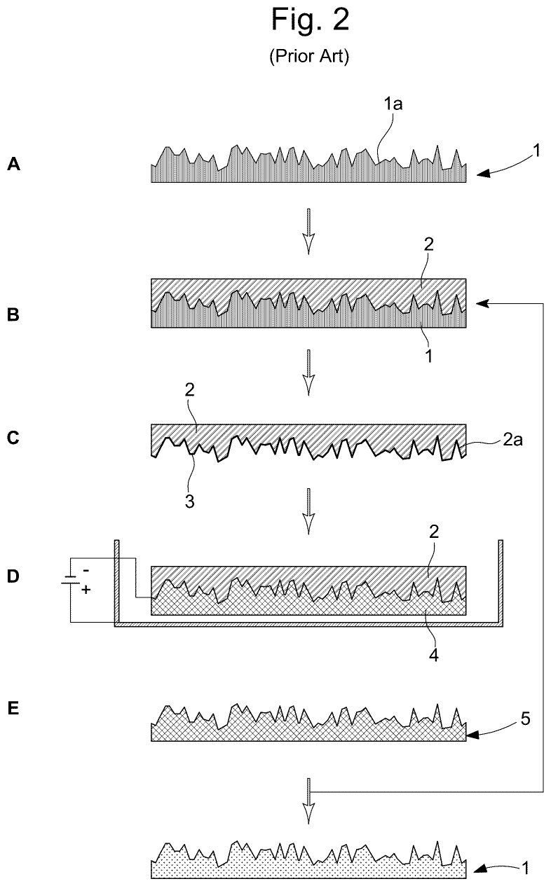

FIG. 3 diagrammatically shows the production method according to an alternative embodiment of the invention with 2D shaping of the object on the polymer negative replica.

FIG. 4 diagrammatically shows the production method according to another alternative embodiment of the invention with 3D shaping of the polymer negative replica.

### DETAILED DESCRIPTION OF THE INVENTION

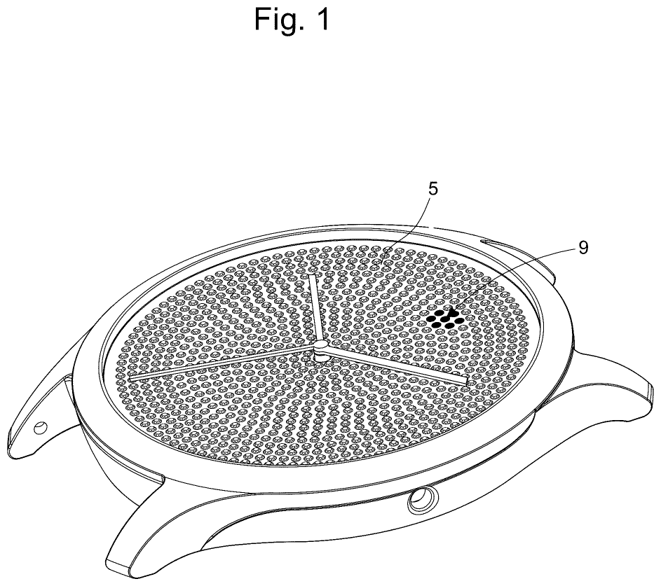

The present invention relates to a method for obtaining a decorative item by replicating a model. This can, for example, be a piece of jewellery or an external component of a timepiece such as a middle, a back, a bezel, a push-piece, a bracelet link, a flange, a dial, a hand or a dial index. The characteristic feature of this item is that at least one of its faces has a sparkling and optionally precious appearance. By way of example, an item 5 in the form of a dial with a logo 9 obtained using the method of the invention is shown in FIG. 1.

The method for obtaining the decorative item 5 includes, as a preamble, the following steps known in the prior art:
Providing or producing a model 1 having a face 1a of polycrystalline structure which is intended to be replicated,
Producing a negative replica 2 of said face 1a using a polymer material,
Separating the negative replica 2 from the model 1,
Optionally, producing an object 4, also referred to as a positive replica, on at least a portion of the replicated face 2a of the negative replica 2,
said decorative item 5 being either the negative replica 2 or the positive replica 4.

The model 1 with the polycrystalline structure is obtained by natural polycrystalline growth, also referred to as self-assembly. This produces smooth facets on an atomic scale as well as perfect edges. For example, polycrystalline growth can be achieved by evaporation, by vacuum arc generated or microwave plasma or by hot filaments. In all cases, temperature is a factor governing the growth of the crystals in the model.

The polycrystalline material of the model 1 can be, for example, a metal, diamond or ceramic material. Alternatively, the model could also be a part produced from a previously-made replica. In this case, the face to be replicated has a crystalline structure, which can also be described as a pattern reproducing a crystalline structure, which has not been obtained by natural polycrystalline growth. In both cases, this concerns a model 1 with a surface 1a having a polycrystalline structure.

The object 4 can be obtained by electroforming a metal on the replicated face 2a which has previously been coated with a conductive layer 3, by injecting material onto the negative replica 2 used as an insert in a mould or by stamping a material onto the replicated face 2a. The object 4 is made of a metal or a metal alloy when it is obtained by galvanic growth. The object is made of ceramic, a metal that can be amorphous, a polymer or a composite material if it is obtained by injection moulding or stamping. When the item 5 is the negative replica 2, it is made of a polymer.

According to the invention, a decorative and/or functional effect is obtained on the item by one or more of the following actions, which are carried out during the production method, on the model 1, on the negative replica 2, or on both.

In order to obtain particular optical effects, the actions are carried out on the model 1 during its production or after its production. During the self-assembly growth process of the model 1, the growth parameters and in particular the temperature are modified locally and in a controlled manner in order to selectively vary the size and/or orientation of the crystals on the surface of the model 1. This results in an additional optical effect in terms of sparkle for enhanced aesthetics. For functional and/or decorative purposes, local variation of the growth parameters can be used to inscribe a logo, create polycrystalline appliques or any other decoration on the polycrystalline surface 1a of the model 1.

Once the model 1 with the polycrystalline structure 1a has been produced, the shape of the crystals can also be modified by reworking and truncating their vertices and faces. This can be carried out, for example, by selective laser etching or local mechanical machining. This also results in an additional optical effect in terms of sparkle for enhanced aesthetics. This makes it possible, for example, to create a holographic image. For functional purposes, it can be used to inscribe hidden data such as a discrete logo, a data matrix, or a serial number, etc. that can be read using a special optical device. The shape of the crystals can be modified either on the original model 1 or on a positive replica 4 which serves as a model.

According to the invention, the actions during and after production of the model 1 can be combined.

Actions can also be carried out on the polymer negative replica 2. This involves 2D, 2.5D and/or 3D shaping with the aim of improving the aesthetic appearance and/or adding functionality. Shaping consists of structuring the negative replica 2 before producing the object 4.

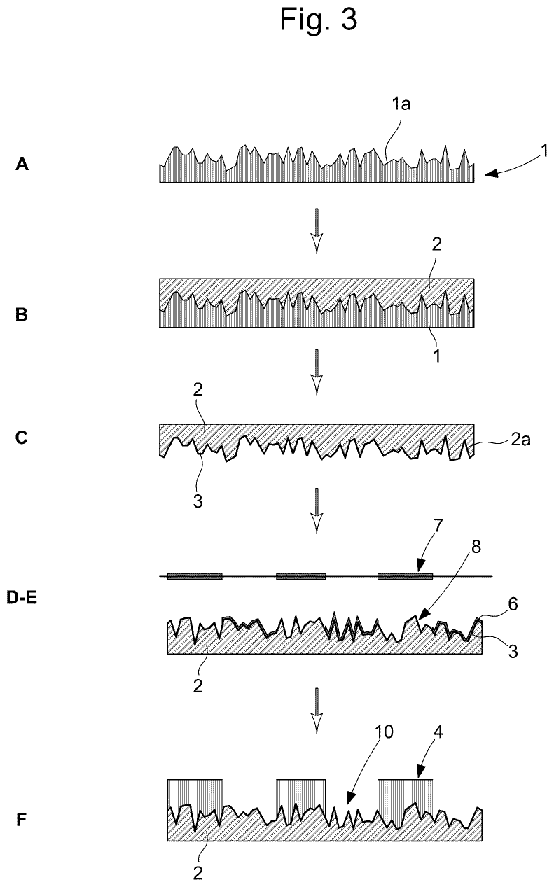

The LIGA method is used for the 2D shaping of the object 4 on the negative replica 2, as shown in FIG. 3. After deposition of the conductive layer 3 (C) on the face 2a of the replica 2, for example by PVD vacuum deposition, and before the galvanic growth of the object 4, a photoresist layer 6 is deposited on at least part of the face 2a (D). It is selectively irradiated, either through a previously structured mask 7 (E), i.e. by conventional photolithography as illustrated in FIG. 3, or by laser lithography on certain portions without the need for a mask. The irradiated photoresist portions are removed—or vice versa depending on whether the photoresist used is positive or negative respectively—by chemical means to create cavities 8 in which the object 4 is then produced by electroforming (F). This makes it possible to create items with complex contours, through-holes 10, and sharp edges, etc., while retaining a sparkling polycrystalline surface.

For 2.5D shaping, the method is substantially the same, with the steps of depositing the conductive layer and irradiating the photoresist layer repeated on a plurality of levels to create tiers, or blind holes, etc.

For 2D and 2.5D shaping, conventional machining can also be used to add complex structures.

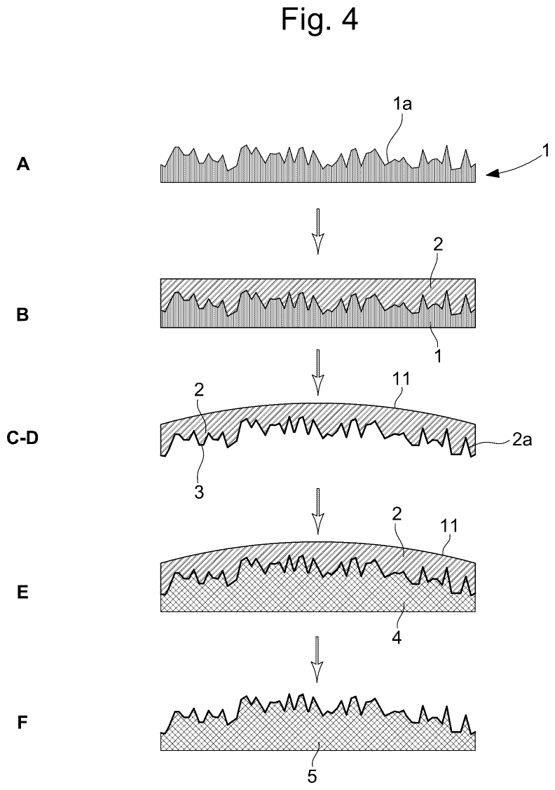

For 3D shaping, a negative replica 2 must be produced using a flexible polymer, for example silicone. The method is illustrated in FIG. 4, and consists in shaping the flexible replica 2 to the desired shape and fastening it in this shape, for example by placing it on a rigid substrate 11 of the desired shape, which can be, by way of illustration, a second rigid polymer (C). The replica 2 can, for example, be bonded to the rigid substrate 11. The shapes may vary. They can be domed, spherical, cylindrical, etc. The conductive layer 3 required for galvanic growth is then deposited (D). Alternatively, the polymer 2 can be shaped after the metal layer 3 has been deposited. Galvanic growth is then carried out (E) to produce the object 4. Alternatively, the flexible polymer replica 2 shaped in this manner could be used as an insert in an injection mould, the object being obtained by injecting a ceramic or metal or any other injectable material into the mould or by stamping. This makes it possible to create 3D items with a sparkling polycrystalline surface (F). For example, polycrystalline hands, polycrystalline middles or links with a polycrystalline structure can be produced.

The items obtained with the various replication methods above can then be finished with shaping methods such as conventional machining, laser, water jet and colouring methods for example by PVD, CVD, ALD or by galvanic growth in the case of a metallic object. Vacuum deposition of a thin, precious metal layer (gold, gold alloy, Pt, etc.) or of a precious metal appearance (yellow TiN, etc.) gives the item a precious appearance with a sparkling effect. Colouring with a lacquer, for example, will create an object without a precious appearance but with the sparkling effect.

In an alternative embodiment of the invention, colouring by vacuum deposition is carried out conformally on the facets of the polycrystalline structure. In the case of directional PVD, this involves normal incidence on the surface of the negative replica or object or rotation of the part in order to obtain homogeneous colouring.

In another alternative embodiment of the invention, the directional nature of PVD methods, in particular evaporation, is used to colour the polycrystalline surface of the negative replica or object by metallisation or deposition of dielectric layers with an inclined or grazing incidence, thus covering the facets only at a certain orientation to give a particular optical appearance.

### NOMENCLATURE

1. Model
a. Polycrystalline surface
2. Negative replica
a. Replicated face
3. Conductive layer
4. Object, also referred to as the positive replica
5. Decorative item
6. Photoresist layer
7. Mask
8. Cavity
9. Logo
10. Hole
11. Rigid substrate

1. A method for obtaining a decorative item (5) having a sparkling appearance, said method comprising the steps of:
providing or producing a model (1) having a surface (1a) of polycrystalline structure which is intended to be replicated,
producing a negative replica (2) of said surface (1a) using a polymer material,
separating the model (1) from the negative replica (2),
followed by an optional step of:
producing an object (4), also referred to as a positive replica, on at least a portion of the replicated face (2a) of the negative replica (2),
wherein one or more actions are implemented during the steps to impart particular optical effects and/or a functional appearance to the decorative item (5), one or more of the actions being selected from the following:
locally modifying the polycrystalline structure of the model (1),
modifying the shape of the negative replica (2),
selectively producing the object (4) on certain portions of the replicated face (2a) of the negative replica (2) if the optional step is carried out,
the decorative item (5) obtained being either the negative replica (2), or the positive replica (4) if the optional step is carried out.

2. The production method according to claim 1, wherein the polycrystalline structure of the model (1) is modified during the production thereof, by locally changing the temperature of the model (1) during crystal growth.

3. The production method according to claim 1, wherein the structure of the surface (1a) of the model (1) is modified after the production thereof, by reworking the shape of certain crystals.

4. The production method according to claim 3, wherein the shape of the vertices and faces of some of the crystals of the surface (1a) of the model (1) is modified by selective laser etching or by local mechanical machining.

5. The production method according to claim 1, wherein the object (4) is produced selectively on certain portions of the replicated face (2a) of the negative replica (2) in view of the 2D shaping of the object (4) on the replicated face (2a) of the negative replica (2), the object (4) being produced by the LIGA method with the sub-steps of:
Depositing a conductive layer (3) on the replicated face (2a) of the negative replica (2),
Depositing a photoresist layer (6) on the conductive layer (3),
Selectively irradiating the photoresist layer (6),
Removing irradiated portions of the photoresist layer (6) or alternatively non-irradiated portions to create cavities (8) revealing the conductive layer (3),
Galvanically growing the object (4) in said cavities (8).

6. The production method according to claim 5, wherein the steps of depositing the conductive layer (3), of depositing the photoresist layer (6), of selectively irradiating the photoresist layer (6), of removing portions of the photoresist layer (6), and of galvanically growing the object (4) are repeated on several levels in view of the 2.5D shaping of the object (4) on the replicated face (2a) of the negative replica (2).

7. The production method according to claim 1, wherein the negative replica (2) is shaped in order to impart a three-dimensional shape to the object (4) during the step of producing said object (4), the step of producing a negative replica (2) being carried out with a flexible polymer such as silicone, the negative replica (2) then being shaped to produce the desired shape and fixed in this shape.

8. The production method according to claim 7, wherein the negative replica (2) is fixed in said shape by fixing to a rigid substrate (11).

9. The production method according to claim 1, wherein the object (4) is produced by electroforming, by injection or by stamping.

10. The production method according to claim 1, wherein the object (4) is made from a material selected from a metal, a metal alloy, a ceramic, a polymer and a composite material.

11. The production method according to claim 1, further comprising an additional step of colouring the object (4) or the negative replica (2) if the latter is intended to form the article (5), colouring being carried out by vacuum deposition on the object (4) or on the negative replica (2) or by galvanic growth on the object (4) if said object (4) is metallic.

12. The production method according to claim 11, wherein the object (4) is coloured by a metallic or dielectric deposit applied by directional PVD with an inclined or grazing incidence so that the facets of the replicated polycrystalline surface are covered only in a certain direction in order to obtain a particular optical effect.

13. A decorative item (5) having a sparkling appearance obtained using the method according to claim 1, wherein said decorative item (5) is a piece of jewellery or an external timepiece component.

14. The decorative item (5) according to claim 13, wherein the external timepiece component is a middle, a dial, a hand, an applique or a link.

15. The decorative item (5) according to claim 13, wherein it includes one or more patterns, a relief and/or a non-planar shape.

16. The decorative item (5) according to claim 15, wherein the one or more patterns and the relief are chosen from a logo (9), a holographic image, a serial number, a data matrix and a hole (10).

17. The decorative item (5) according to claim 13, wherein the decorative item also has a precious appearance.
